(19) United States
(12) Patent Application Publication
(10) Pub. No.: US 2026/0142197 A1
(43) Pub. Date: May 21, 2026

(54) CARBON NITRIDE COATED NITROGEN DOPED PtNi OXYGEN REDUCTION REACTION CATALYST FOR PROTON EXCHANGE MEMBRANE FUEL CELLS

(71) Applicant: Toyota Motor Engineering & Manufacturing North America, Inc., Plano, TX (US)

(72) Inventors: Liang Wang, Saline, MI (US); Li Qin Zhou, Okemos, MI (US); Kotaro Sasaki, Hauppage, NY (US); Xueru Zhao, New York, NY (US)

(73) Assignees: Toyota Motor Engineering & Manufacturing North America, Inc., Plano, TX (US); Toyota Jidosha Kabushiki Kaisha, Aichi-ken (JP); Brookhaven Science Associates, LLC, Upton, NY (US)

(21) Appl. No.: 18/949,230

(22) Filed: Nov. 15, 2024

(51) Int. Cl. H01M 4/92; H01M 4/86; H01M 8/10

(52) U.S. Cl. CPC H01M 4/923; H01M 4/8621; H01M 4/8657; H01M 2004/8689; H01M 2008/1095

(57) ABSTRACT

Disclosed are catalysts having high activity, stability, and durability, methods for making, and fuel cells comprising the catalysts. The catalysts include nitrogen-doped platinum (Pt) containing nanoparticles comprising platinum and nickel, having a carbon nitride coating on exterior surfaces thereof loaded on a carbon support, wherein said nanoparticles have an average diameter between about 1.5 nm to 8.0 nm.

### STATEMENT REGARDING FEDERALLY SPONSORED RESEARCH OR DEVELOPMENT

The present application was made with government support under contract number DE-SC0012704 awarded by the United States Department of Energy. The United States government has certain rights in the invention(s).

### TECHNICAL FIELD

The present disclosure generally relates to catalysts, and particularly to carbon nitride coated nitrogen-doped platinum/nickel catalyst loaded on a carbon support having high activity and stability for polymer electrolyte membrane fuel cells.

### BACKGROUND

Fuel cell vehicles (FCVs) are considered to be more efficient than conventional internal combustion engine vehicles. Current commercially available fuel cell vehicles use polymer electrolyte membrane fuel cells (PEMFCs), which have attracted attention as an energy source for transportation instead of conventional internal combustion engines because they have a high-power density, operate at low temperatures, and have zero emission of harmful gases. Oxidation-reduction reactions (ORR), also known as redox reactions, are central to converting chemical energy into electrical energy. These reactions occur at two electrode layers, the anode and the cathode, separated by a proton exchange membrane. During fuel cell operation, the anode is supplied with hydrogen as a fuel and oxygen as an oxidant to the cathode. Then, fuel is oxidized to protons at the anode, and oxygen is reduced to water at the cathode to generate electricity.

Platinum catalysts are used in both the anode and cathode layers to facilitate the ORR reaction and to provide chemical stability, corrosion resistance, and durability to the fuel cell. In particular, platinum-containing catalysts provide excellent catalytic properties for the reduction of oxygen at the cathode which is important because the ORR is kinetically slower and more complex than the hydrogen oxidation reaction that occurs at the anode. Thus, the catalyst at the cathode is a main factor that determines the power generation characteristics of the PEMFC, and improving its ORR activity and performance is an important issue. For both the anode and the cathode, an electrode catalyst for a fuel cell made of fine powder in which catalyst particles made of a noble metal such as platinum (Pt) are supported on a carrier, such as carbon. A major challenge for future hydrogen FCV's is to make them economically feasible which requires significant cost reduction and power efficiency improvement.

Platinum-based alloy catalysts have been reported to have improved ORR activity, but such catalysts have been shown to lack long-term durability under fuel cell operating conditions due to a lack of the ability to stabilize transition metals in Pt-based alloys under acidic ORR conditions. Other challenges with platinum-containing catalysts include platinum particle agglomeration, dissolution, and poisoning of anode and/or cathode materials of the PEMFC, which can lead to reduced ORR activity of the catalyst and overall efficiency of the fuel cell.

Thus, it would be desirable to develop PEMFC electrode catalyst having superior ORR catalytic activity, while maintaining stability and durability.

### SUMMARY

This section provides a general summary of the disclosure and is not a comprehensive disclosure of its full scope or all of its features. In various aspects, the present teachings provide a catalyst comprising nitrogen-doped platinum (Pt) containing nanoparticles comprising platinum (Pt) and nickel (Ni), having a carbon nitride (CN) coating on exterior surfaces thereof loaded on a carbon support, wherein said nanoparticles have an average diameter between about 1.5 nm to 8.0 nm. In some examples the platinum (Pt) containing nanoparticles have an average particle diameter between about 1.5 nm and about 4.0 nm or an average particle diameter between about 1.8 to about 3.0 nm.

In some examples, the carbon nitride coating comprises CNx, wherein x represents a molar ratio of nitrogen (N) to carbon (C) in a range of 0.1≤x≤4.

In some examples, the carbon support is a mesoporous carbon support, comprising a predetermined hierarchical pore distribution architecture (MPC-HPDA), which comprises a plurality of pores with a majority percentage of the plurality of pores having an average pore diameter between about 2.0 nm to about 8.0 nm. In some examples, at least a portion of the platinum (Pt) containing nanoparticles is disposed within a majority percentage of a plurality of pores having an average diameter between about 2.0 nm to about 8.0 nm. In other examples, a majority percentage of a plurality of pores of the mesoporous carbon support are mesopores having an average diameter between about 2.0 to 8.0 nm is more than 70%.

In some aspects, the present disclosure provides a method for making a catalyst for a fuel cell, wherein the catalyst comprises nitrogen-doped platinum (Pt) containing nanoparticles having a carbon nitride coating on exterior surfaces thereof loaded on a carbon support, wherein said nitrogen-doped platinum (Pt) containing nanoparticles have an average diameter between about 2.0 nm to 8.0 nm. The method comprises:
dispersing a platinum precursor, a nickel precursor, nitrogen source, and a carbon support material in a solvent to provide a precursor mixture,
drying the precursor mixture and annealing under an argon gas flow at a temperature between about 200° C. to about 500° C. for about 2-3 hours forming carbon nitride coated nitrogen-doped platinum nickel nanoparticles on a carbon support,
wherein the nitrogen source is selected from urea, melamine, and aniline, and
wherein said nanoparticles have an average diameter between about 1.5 nm to about 8.0 nm.

In some examples, the nitrogen source is urea. The ratio of nickel to urea may be 1:5 to 1:10.

In some examples, the annealing may be at a temperature of about 500° C. In other examples, the annealing may be about 2 hours.

In some examples the platinum (Pt) containing nanoparticles have an average particle diameter between about 1.5 nm and about 4.0 nm or an average particle diameter between about 1.8 to about 3.0 nm.

In some examples, the carbon nitride coating comprises CNx, wherein x represents a molar ratio of nitrogen (N) to carbon (C) in a range of 0.1≤x≤4.

In some examples, the carbon support is a mesoporous carbon support, comprising a predetermined hierarchical pore distribution architecture (MPC-HPDA), which comprises a plurality of pores with a majority percentage of the plurality of pores having an average pore diameter between about 2.0 nm to about 8.0 nm. In some examples, at least a portion of the platinum (Pt) containing nanoparticles is disposed within a majority percentage of a plurality of pores having an average diameter between about 2.0 nm to about 8.0 nm. In other examples, a majority percentage of a plurality of pores of the mesoporous carbon support are mesopores having an average diameter between about 2.0 to 8.0 nm is more than 70%.

In some other aspects, the present disclosure provides a fuel cell comprising:
an anode, a cathode, and a polymer electrolyte membrane disposed between the anode and the cathode; and a cathode catalyst disposed on the cathode,
wherein the cathode catalyst comprises nitrogen-doped platinum (Pt) containing nanoparticles having a carbon nitride coating on exterior surfaces thereof loaded on a carbon support, and
wherein said nanoparticles have an average diameter between about 2.0 nm to about 8.0 nm.

In some examples, the carbon nitride coating comprises CNx, wherein x represents a molar ratio of nitrogen (N) to carbon (C) in a range of 0.1≤x≤4.

In some examples, the carbon support is a mesoporous carbon support, comprising a predetermined hierarchical pore distribution architecture (MPC-HPDA), which comprises a plurality of pores with a majority percentage of the plurality of pores having an average pore diameter between about 2.0 nm to about 8.0 nm. In some examples, at least a portion of the platinum (Pt) containing nanoparticles is disposed within a majority percentage of a plurality of pores having an average diameter between about 2.0 nm to about 8.0 nm. In other examples, a majority percentage of a plurality of pores of the mesoporous carbon support are mesopores having an average diameter between about 2.0 to 8.0 nm is more than 70%. Further, areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1 is a schematic illustration of an example of a polymer electrolyte membrane fuel cell (PEMFC).

FIG. 2 is a schematic cross-sectional view of an example of a membrane electrode assembly (MEA).

FIG. 3 is an illustration of a reaction coordinate graph diagram that provides an energy profile for the electrochemical reduction of oxygen on a Pt (111) surface, illustrating the sequence of intermediate states and the corresponding changes in free energy.

FIG. 4A is a schematic illustration of a typical PEMFC.

FIG. 4B is an illustration of an enlarged view of an interface section labeled 4B in FIG. 1A.

FIG. 4C is an illustration of an enlarged view of a carbon support material loaded with Pt-containing nanoparticles at the interface in FIG. 4B.

FIG. 5A is a schematic illustration of an enlarged view of carbon nitride coated nitrogen doped platinum (Pt) containing nanoparticles loaded on a carbon support.

FIG. 5B is a Transmission Electron Microscopy (TEM) image of CNx coated PtNiN nanoparticles of the present disclosure.

FIG. 5C is a an Xray Photoelectron Spectroscopy (XPS) spectrum showing that C—N bonds were detected on the surface without any C—C bonds confirming that a carbon nitride coating layer is formed on the nanoparticle surface.

FIG. 6A is a schematic illustration of an enlarged view of a mesoporous carbon support particle of the present disclosure having a predetermined hierarchical pore distribution architecture.

FIG. 6B is a schematic illustration of an enlarged view of a composite particle of the present disclosure comprising a mesoporous carbon support particle having a predetermined hierarchical pore distribution architecture and the carbon nitride coated Pt-containing nanoparticles of the present disclosure disposed within the plurality of pores of the mesoporous carbon support.

FIG. 7 is an illustration of a plot of intensity versus 2θ angle for an X-ray diffraction (XRD) scan of sample S1 containing a CNx-PtNiN/MPC catalyst having an average particle size of about 2.8 nm.

FIG. 8 is an illustration of a plot of intensity versus 2θ angle for an X-ray diffraction (XRD) scan of sample S2 containing a CNx-PtNiN/MPC catalyst having an average particle size of about 2.1 nm.

FIG. 9 is an illustration of a plot of intensity versus 2θ angle for an X-ray diffraction (XRD) scan of sample S3 containing a CNx-PtNiN/MPC catalyst having an average particle size of about 2.5 nm.

FIG. 10 is an illustration of a plot of intensity versus 2θ angle for an X-ray diffraction (XRD) scan of sample S4 containing a CNx-PtNiN/MPC catalyst having an average particle size of about 1.8 nm.

FIG. 11 is an illustration of a plot of intensity versus 2θ angle for an X-ray diffraction (XRD) scan of sample S5 containing a CNx-PtNiN/MPC catalyst having an average particle size of about 3.0 nm.

FIG. 12 is an illustration a plot of intensity versus 2θ angle for an X-ray diffraction (XRD) scan of sample S6 containing a PtNiN/MPC catalyst having an average particle size of about 2.1 nm.

FIG. 13 is a graphical illustration of the mass activity retention in MEAs for sample S1 of Example 1 containing an CNx-PtNiN/MPC catalyst of the present disclosure as compared to Sample S6 containing a PtNiN/MPC catalyst (comparative example).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

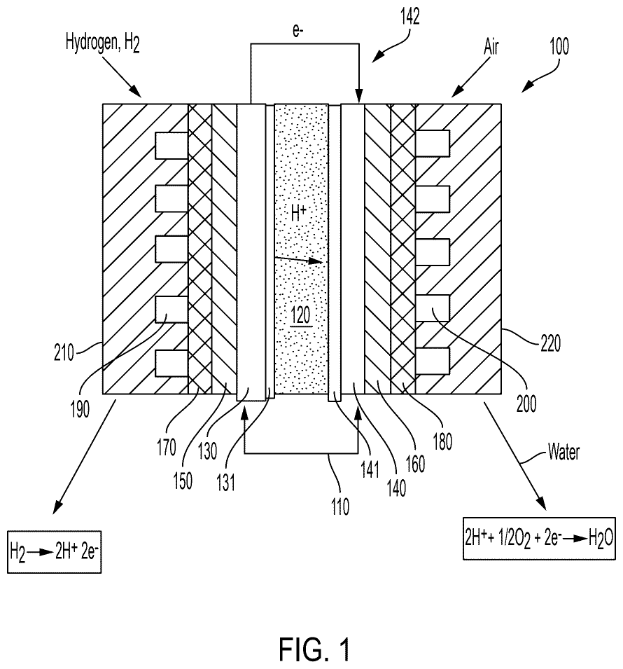

The present disclosure provides an electrode catalyst (also referred to herein as a “catalyst material”) having enhanced activity for oxidation-reduction reactions (“ORR”), which can advantageously be used as a cathode catalyst in polymer electrolyte membrane fuel cells (“PEMFCs”) for improved activity and stability. FIG. 1 presents one representation of an example of a fuel cell 100. The fuel cell 100 includes a membrane-electrode assembly (MEA) 110 comprising a proton exchange membrane (PEM) 120, positioned between an anode 130 and a cathode 140, and an external electrical circuit 142 that electrically connects the anode 130 and the cathode 140. A first microporous layer 150 (also referred to herein as an “anodic microporous layer” (AMPL) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer” (CMPL) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel gas is typically hydrogen. The hydrogen gas may be stored in a storage tank. Optionally, hydrogen may be stored as metal hydrides or may be hydrogen obtained by reforming a hydrocarbon fuel. The oxidizing gas is typically an oxygen-containing gas. In some embodiments, the oxidizing gas is ambient air. Hydrogen and air flow within the cell are illustrated in FIG. 1. Hydrogen (H₂) is fed to the anode side of the fuel cell and an oxygen source (such as ambient air) is fed to the cathode side of the fuel cell. In FIG. 1, water and excess air are depicted as exiting the cathode side of the fuel cell, and unreacted hydrogen is shown as exiting the anode side of the fuel cell.

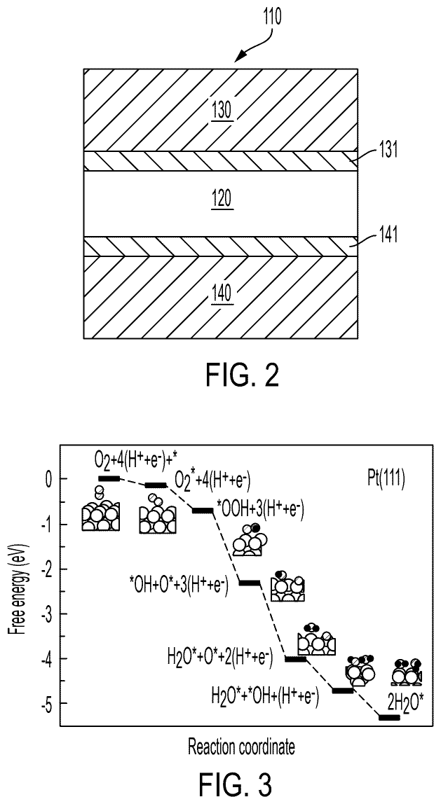

FIG. 2 is an illustration of the membrane-electrode assembly (MEA) 110 comprising a proton exchange membrane 120, an anode 130, and a cathode 140. The anode 130 comprising an anodic catalyst layer 131, configured to electrolytically catalyze an anodic hydrogen-splitting reaction:

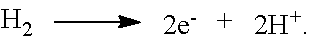

The anodic catalyst layer can be substantially formed of anodic catalyst particles of platinum, or a platinum alloy supported on carbon, such as carbon black.

The cathode 140, comprises a cathodic layer 141, configured to catalyze an oxygen reduction reaction:

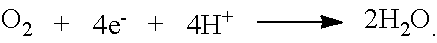

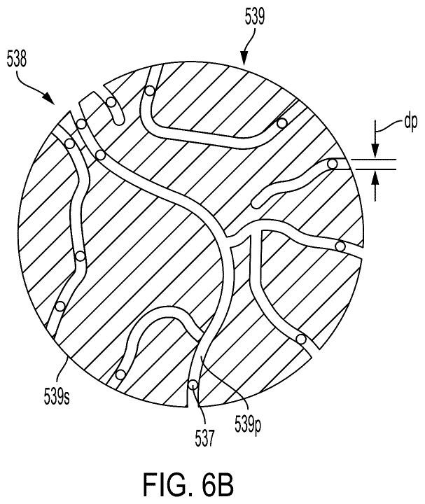

Platinum is widely used as a cathode catalyst in electrochemical reactions, such as in fuel cells, because of its exceptional ability to speed up the oxygen reduction reaction (ORR). The graph in FIG. 3 illustrates how platinum acts as an efficient catalyst during the electrochemical reduction of oxygen in a PEMFC by lowering the activation energy, stabilizing intermediates, and steering the ORR towards a more efficient and desired chemical pathway, thus significantly enhancing the overall reaction kinetics and thermodynamics on the Pt (111) surface. In the initial state, O₂+4H⁺+4e⁻→*, molecular oxygen (O₂) is adsorbed onto the platinum surface. This state involves the transfer of four protons (H⁺) and four electrons (e⁻) to the platinum surface, preparing the oxygen molecule for further reduction. As the graph descends, it shows the formation of *OOH (hydroperoxide) and subsequently *OH (hydroxyl) and *O (atomic hydrogen) intermediates. The oxygen molecule is further reduced and adsorbed on the platinum surface as an intermediate species, denoted as O₂*. The initial energy state at this step is around 0 eV. In the next step, the O₂* species further reacts with a proton and an electron to form the hydroperoxide radical (*OOH) on the surface. This step results in a decrease in free energy, indicating that the formation of *OOH is energetically favorable. The *OOH intermediate undergoes additional reduction, losing an oxygen atom and forming two separate adsorbed species: hydroxyl (*OH) and atomic oxygen (*O). At this step there is a significant drop in free energy. One *O atom reacts with a hydroxyl group (OH) and additional protons and electrons to form a water molecule (H₂O) while leaving another *OH on the platinum surface. Platinum catalyzes these steps by providing a surface that facilitates the transfer of electrons and protons to the adsorbed oxygen species, progressively reducing and splitting the molecule. In the final step the remaining *OH group is converted into another water molecule through the reaction with another proton and electron, resulting in two adsorbed water molecules on the surface. The presence of platinum ensures that the reaction follows the four-electron pathway directly to water. This is represented by the decline in energy as intermediate species are transferred stepwise into water molecules. As can be seen in the graph in FIG. 6, throughout the reaction pathway, free energy decreases, indicating that the reaction is an exergonic reaction, (i.e., releases energy). The lowest energy state is reached with the formation of two (2) water molecules indicating this as the most stable product of this reaction pathway on Pt (111).

Platinum's unique surface properties not only adsorb and activate the reactants but also stabilize the intermediate reaction species, allowing controlled and sequential reaction steps as depicted in FIG. 3. Previous approaches to producing catalyst particles with a higher catalytic activity and reduced loading of costly precious metals have typically involved the use of one or more components that are susceptible to corrosion in alkaline or acidic environments such as PtM, where M is a transition metal such as Ni, Co, or Fe. Over time, the gradual loss of these elements and their subsequent buildup in other critical components present within the energy conversion device, e.g., an electrolyte membrane, reduces both the activity level of the catalyst particles and the overall efficiency of the device.

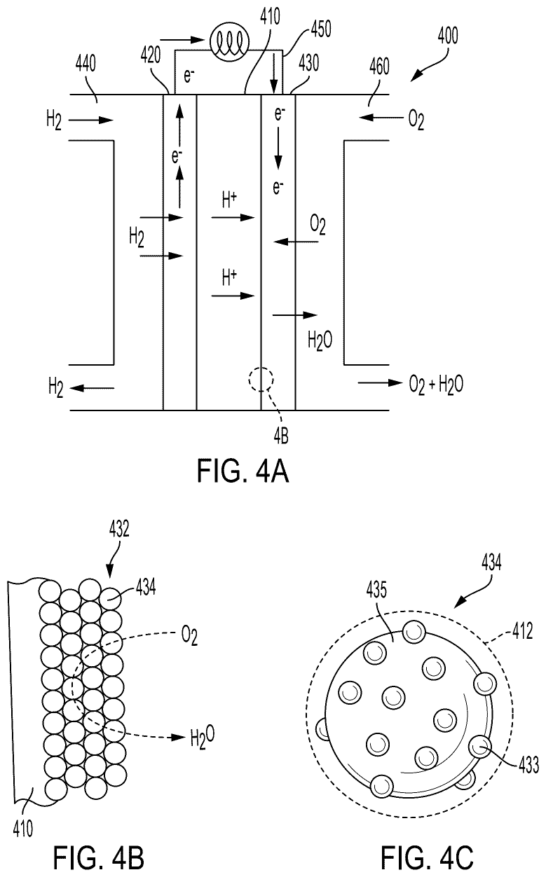

FIGS. 4A-4C illustrate the components and operation of a typical PEMFC 400. The PEMFC 400 in FIG. 4A includes a PEM 410 sandwiched between an anode 420 and a cathode 430, and an external electrical circuit 450 that electrically connects the anode 420 and the cathode 430. The cathode 430 includes a catalyst layer 432 with a plurality of composite particles 434 as illustrated in FIG. 4B, and the composite particles 434 include a plurality of Pt-containing nanoparticles 433 supported on the surface of carbon particles 435 as illustrated in FIG. 4C (only one carbon particle 435 shown). As illustrated in FIG. 4A, during operation of the PEMFC 400, hydrogen (H₂) gas is provided to and flows through an anode-side inlet 440 and oxygen (O₂) gas (e.g., O₂ in air) is provided to and flows through a cathode-side inlet 460. At least a portion of the H₂ flows into contact with the anode 420 and migrates to the PEM 410 where H₂ molecules are catalyzed into H⁺ ions plus electrons ‘e−’ (e.g., via an anode catalyst layer—not shown). Also, at least a portion of the O₂ gas flows into contact with the cathode and migrates to the PEM 410. The electrons e− flow through the external electrical circuit 450 to the cathode 430 and react with O₂ molecules to form O₂₋ ions (e.g., via the cathode catalyst layer 432) and the H⁺ ions diffuse through the PEM 410 to the cathode 430 and react with the O₂₋ ions to form H₂O (water), which is then transported out of the PEMFC 400 with the flow of unreacted O₂. In this manner, the Pt-containing nanoparticles 433 assist in and enhance the reaction of O2+e− to O₂₋ and/or O₂₋+H+ to H₂O and electricity is generated by the PEMFC 400.

Referring specifically to FIG. 4C, in some examples an ionomer 412 from the PEM 410 is in contact with and at least partially surrounds the composite particles 434. And in such examples, the ionomer 412 can poison the plurality of Pt-containing nanoparticles 433 (also known as “ionomer poisoning”) such that the efficiency of the catalyst layer 432 decreases. In addition, the plurality of Pt-containing nanoparticles 433 supported on an outer surface of the carbon particle 435 can agglomerate and/or increase in size such that an average effective size of the Pt-containing nanoparticles increases and the efficiency of the catalyst layer 432 decreases. That is, increasing the average particle size of the Pt-containing particles reduces the surface area to volume ratio of the Pt-containing particles, which in turn reduces the surface area available to catalyze the O₂+e− to O₂₋ and/or O₂₋+H+ to H₂O reaction(s). Accordingly, ionomer poisoning and nanoparticle growth, either by agglomeration or particle size growth, are problematic for PEMFCs.

Previous efforts to develop PEMFC catalysts involve platinum-based alloy nanoparticles, PtM, where M is a transition metal such as Ni, Co, and/or Fe, which exhibited improved ORR activity. However, such catalysts lacked sufficient durability in long term operation of a PEMFC due to a lack of the ability to stabilize transition metals under acidic ORR conditions. For example, among various reported platinum-based alloy catalysts having high ORR activity and membrane electrode assembly (MEA) performance, PtNi₃ exhibited significant Ni degradation (only ˜15% Ni remained) during an accelerated durability test (ADT).

Ordered intermetallic PtM-based nanoparticles, where M is a transition metal, have attracted attention for providing significantly improved activity and durability for ORR. Compared to alloy nanoparticles, ordered intermetallic PtM-based nanoparticles show a strong atomic interaction between Pt and M leading to high chemical and structural stability, and modulation of the composition ratio of M to Pt to achieve higher mass activity (MA) for the ORR. Recent density functional theory studies have shown that both the linear compressional and shear strain effects provided by 3D alloying elements in PtM contribute to the optimal adsorption on the reaction intermediates. Thus, it is considered that inducing tensile strains within the Pt surface of PtM catalysts will improve the ORR kinetics. However, too much tensile strain can damage the structure of PtM catalysts and the stability of the ORR. Therefore, controlling tensile strain is important. Anion doping, such as nitrogen-doping (N-doping) is a strategy used to provide optimal strain fields on the surface of the Pt shell. Additionally, the anion dopant reacts with the core compounds to form a metal nitride core and form chemically stable core compounds.

The present inventors previously developed a nitrogen-doped (“N-doped”), or nitrogen-stabilized (“N-stabilized”), ternary catalyst loaded on a carbon support and demonstrated that N-doped PtNiN/C catalysts exhibited higher activity and durability compared with PtM alloy catalysts. A carbon support can be effective to protect catalysts from agglomeration of nanoparticles and improve the conductivity and stability of the catalyst and the present inventors have studied employing a commercial mesoporous carbon, such as Ketjenblack (KB), as a support for Pt-containing catalysts as a way to improve ORR activity, stability, and durability. The present inventors previously developed solid-solution (SS) and intermetallic (IM) N-doped PtNiN catalysts supported on commercial KB carbon (PtNiN/KB) and demonstrated that the PtNiN/KB catalysts showed enhanced ORR activity and durability compared with PtNi/C catalysts. See, for example, U.S. Pat. Nos. 9,822,222, 10,501,321, and 10,680,249, and PG Pub. No. 2024/0186535A1, incorporated herein by reference in their entirety.

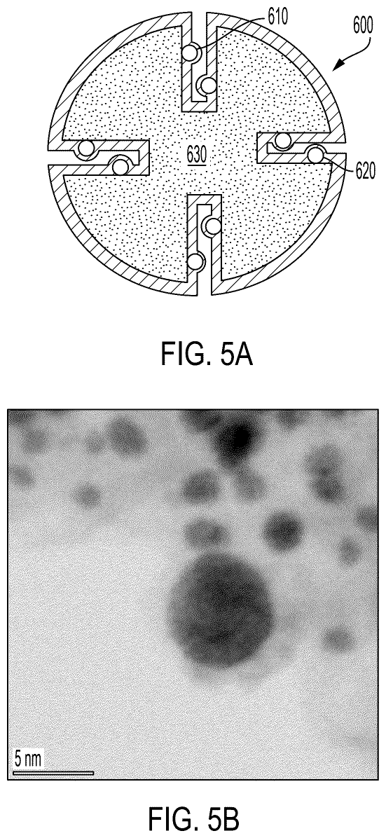

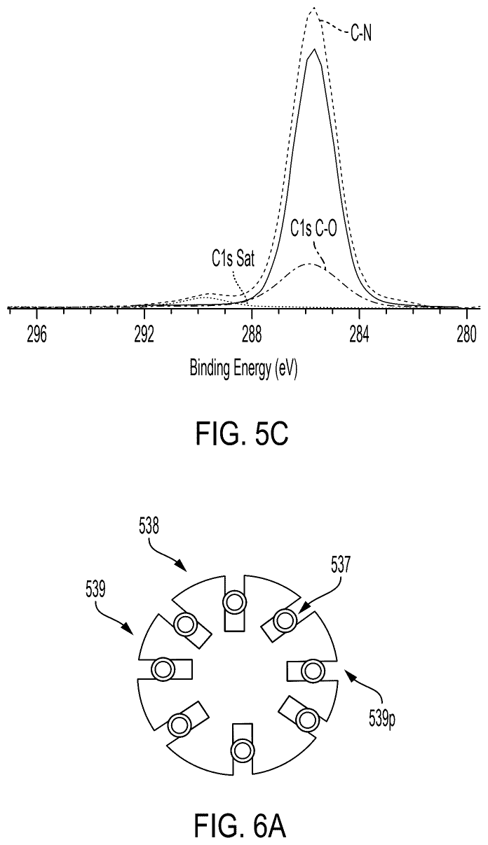

The present disclosure provides nitrogen-doped platinum (Pt) containing nanoparticles comprising platinum (Pt) and nickel (Ni), having a carbon nitride coating on exterior surfaces thereof loaded on a carbon support (CNx-PtNiN), and having an average diameter between about 1.5 nm to 8.0 nm. FIG. 5A is a schematic illustration of the structure of the catalyst 600 of the present disclosure. As illustrated, nitrogen-doped platinum (Pt) containing nanoparticles 610 comprising platinum (Pt) and nickel (Ni) are loaded on a carbon support 620, and the exterior surfaces of the nitrogen-doped platinum (Pt) containing nanoparticles 610 are coated with a carbon nitride layer 630. FIG. 5B is a Transmission Electron Microscopy (TEM) image showing the carbon nitride coated on the exterior surfaces of the nitrogen-doped platinum containing nanoparticles as evidenced by the shadow, i.e., carbon nitride coating, surrounding the large dark circle which represents the nitrogen-doped platinum containing nanoparticles. FIG. 5C is an X-ray Photoelectron Spectroscopy (XPS) spectrum which shows the peaks corresponding to the binding energies of electrons from different elements and confirms the C—N bonds were detected on the surface of the catalyst particles without any C—C bonds, thereby confirming formation of carbon nitride on the surfaces of the catalyst nanoparticles.

As used in the present disclosure, the term “nitrogen-doped” refers to the catalyst material wherein nitrogen is incorporated, doped, or included within the core and/or shell via nitridation using a nitrogen containing gas so as to form a metal nitride core. The present inventors have discovered that the combination of (i) a nitrogen-doped (ii) platinum-containing catalyst comprising platinum and nickel, and (iii) having a carbon nitride coating on exterior surfaces thereof loaded on a carbon support provides significant improvement in catalyst durability, MEA performance, and overall PEMFC performance for further commercialization of FCVs as compared to PtNiN/C, without a carbon nitride coating on the surfaces. Without being bound by any particular theory it is considered that nitrogen doping can modify the electronic properties of platinum and enhance its catalytic activity in oxygen reduction reactions. Nitrogen doping can also improve the durability of the catalysts and reduce the amount of platinum needed thereby making the catalyst more cost-effective.

The carbon nitride coated nitrogen-doped platinum (Pt) containing nanoparticles of the present disclosure have a core/shell structure wherein the core particles are encompassed by a platinum shell. The core comprises nitrogen-doped platinum/nickel particles loaded on the carbon support. The carbon nitride layer is coated on the outer surfaces of the platinum shell. The terms “carbon nitride coated” and “having a carbon nitride coating”, “coating”, “layer” and “coating layer” are used interchangeably throughout the specification to refer to the carbon nitride deposited on, in contact with the exterior surfaces of the nitrogen-doped platinum (Pt) containing nanoparticles. The carbon nitride layer or coating may also be considered as surrounding, encompassing, or encapsulating the nitrogen-doped platinum (Pt) containing nanoparticles. In some examples, the carbon nitride coating comprises CNx, wherein x represents the molar ratio of nitrogen (N) to carbon (C) in the range of 0.1≤x≤4. In some examples, carbon nitride is C₃N₄. The carbon nitride coating is believed to protect the platinum-containing catalyst and improve its overall stability, chemical resistance and electronic properties.

The nanoparticle cores may be spherical or spheroidal in shape It is to be understood, however, that the particles may take on any shape or structure which includes, but is not limited to branching, conical, pyramidal, cubical, cylindrical, nanowires, mesh, fiber, octahedral, cuboctahedral, icosahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size may be configured to maximize surface catalytic activity. In an embodiment the nanoparticle cores have external dimensions of less than 12 nm along at least one of three orthogonal directions. Throughout this specification, the exemplary nanoparticles will be primarily disclosed and described as substantially spherical in shape.

The platinum shell is a thin layer of platinum with 1-4 Pt monolayers. Once nanoparticles having the desired shape, composition, and size distribution have been fabricated, the desired shell layer may then be formed. The particular process used to form the shell layer is not intended to be limited to any particular process but is generally intended to be such that it permits formation of films having thicknesses in the monolayer-to-multilayer thickness range. It is to be understood, however, that while the process of preparing core-shell nanoparticles is described sequentially, the cores and the shells of the core-shell nanoparticles can also be formed in parallel.

The carbon nitride coated nitrogen-doped platinum (Pt) containing nanoparticles comprising platinum and nickel have an average particle diameter between about 1.5 nm and about 8.0 nm, between about 1.5 nm and about 4.0 nm, between about 1.8 nm and about 7.7 nm, between about 2.0 nm and about 7.5 nm, between about 2.5 nm and about 7.0 nm, between about 3.0 nm and about 6.5 nm; between about 3.5 nm and about 6.0 nm, between about 4.0 nm and about 4.5 nm, between about 4.0 nm and about 6.0 nm, between about 4.0 and about 5.0 nm, between about 1.5 nm and about 3.5 nm, between about 1.8 nm and about 3.2 nm, between about 1.8 to about 3.0 nm, and between about 2.0 nm and about 3.0 nm.

The carbon support material is selected from conductive carbon structures to physically support the platinum containing nanoparticles. Carbon provides a high surface area to evenly distribute the platinum catalyst, enhances conductivity, and improves the overall durability of the catalyst by reducing aggregation of platinum particles. Carbon is also lightweight and conductive, making it ideal for supporting catalysts in electrochemical applications. In some examples, the carbon support material is a porous carbon selected from mesoporous carbon, Ketjenblack, Vulcan carbon, mesoporous acetyl black (AB), and a metal and nitrogen-doped carbon also referred to as “MNC-derived carbon”.

In some examples the carbon support material is a mesoporous carbon support having a predetermined hierarchical pore distribution architecture (abbreviated herein as “HPDA”) which enhances the activity of the catalyst material. Referring to FIGS. 6A and 6B, the composite carbon nitride coated nitrogen doped PT-containing nanoparticles 638 of the present disclosure may include a plurality of mesoporous carbon particles 639 and a plurality of nitrogen-doped Pt-containing nanoparticles 637 loaded within pores 639p of the mesoporous carbon particles 639. And while not shown in FIGS. 6A and 6B, it should be understood that Pt-containing nanoparticles 637 can be loaded onto and supported by an exterior surface 639s of the mesoporous carbon particles 639.

FIGS. 6A-6B illustrate mesoporous carbon support particles 639 having a predetermined hierarchical pore distribution architecture. The predetermined hierarchical pore distribution architecture is such that the mesoporous carbon support particles 639 comprise a plurality of pores 639p, or openings, and at least a portion of the carbon nitride coated, nitrogen-doped platinum (Pt) containing nanoparticles 637 is disposed within or fit tightly within the plurality of pores 639p. The predetermined hierarchical pore distribution architecture of the mesoporous carbon support of the present disclosure comprises a majority percentage of the plurality of pores 639p, having an average pore diameter, dp, between about 2.0 nm to about 8.0 nm, and at least a portion of the carbon nitride coated nitrogen-doped platinum (Pt) containing nanoparticles 637 is disposed and fit tightly within the majority percentage of the plurality of pores 639p having an average diameter between about 2.0 nm to about 8.0 nm. In some examples, the plurality of pores of the mesoporous carbon support are mesopores having an average diameter between about 2.0 to 8.0 nm is between about 50% to about 95% mesopores or more than 70% mesopores with an average diameter between about 2.0 nm and about 8.0 nm.

In at least one example, the mesoporous carbon particles 639 have a pore size distribution of 5-30% micropores with an average pore diameter less than about 2.0 nm, more than 50-95% mesopores with an average pore diameter between about 2.0 nm and about 8.0 nm, and less than 0-25% macropores with an average pore diameter greater than about 8.0 nm. And in some examples, the mesoporous carbon particles 539 have a pore size distribution of 10-25% micropores with an average pore diameter less than about 2.0 nm, more than 70% mesopores with an average pore diameter between about 2.0 nm and about 8.0 nm, and less than 7.5% macropores with an average pore diameter greater than about 8.0 nm. In addition, the mesoporous carbon particles have a BET surface area greater than 1,000 m²/g, for example, between about 1,000 m²/g and 2,000 m²/g.

Nitrogen-doped platinum (Pt) containing core/shell nanoparticles of the present disclosure can be prepared by any technique known in the art. U.S. Pat. Nos. 9,882,222, 10,501,321, and 10,680,249, which are incorporated herein by reference in their entirety, describe general synthesis methods for forming nitrogen-doped platinum containing catalysts. A one step synthesis method is described by L. Song, et al., “One-Step Facile Synthesis of High Activity Nitrogen-Doped PtNiN oxygen Reduction Catalyst,” ACS Appl. Energ. Mater. 5, 5245-5255 (2022), and a synthesis method for an intermetallic N-doped binary platinum containing catalyst is described by Zhao, et al., “High-Performance Nitrogen-Doped Intermetallic PtNi Catalyst for the Oxygen Reduction Reaction,” ACS Catal. 10, 10637-10645 (2020), each of which is incorporated herein by reference in their entirety.

Once core-shell nanoparticles having the desired shape, composition, and size distribution have been fabricated, the nitrogen may then be introduced into the core. The particular process used to introduce nitrogen into the core is not intended to be limited to any particular process but is generally intended to permit formation of a metal nitride within the core. It is to be understood, however, that while the process of preparing nitride stabilized core-shell nanoparticles is described sequentially, the process of introducing nitrogen into the core can also be done during the core formation, during the shell formation, or both.

The metal nitride formation within the core may be initiated by thermal annealing the core-shell nanoparticles for 1 to 20 hours, followed by exposing the core-shell nanoparticles to a nitrogen precursor at elevated temperatures and ambient pressure for a time sufficient to form a metal nitride. In one embodiment, the amount of metal nitride within the core is between about 20 and 100 wt %. In another embodiment, the amount of metal nitride within the core is between about 30 and 100 wt %. In yet another example, the amount of metal nitride within the core is between about 30 and 80 wt %.

The nitrogen source is selected from urea (CH₄N₂O), melamine (C₃H₆N₆), and aniline (C₆H₅NH₂). In certain embodiments, the nitrogen source is urea (CH₄N₂O). The core-shell nanoparticles may be thermally annealed at about 200, 250, or 300° C. In urea for about 1-5 hours, followed by thermal annealing at a range between about 200-600° C., particularly at about 200, 210, 220, 230, 240, 250, 260, 270, 280, 290 300, 310, 320, 330, 340, 350, 360, 370, 380, 390, 400, 410, 420, 430, 440, 450, 460, 470, 480, 490, 500, 510, 520, 530, 540, 550, 560, 570, 580, 590 or 600° C. in urea for about 2-3 hours. In another example, the disclosed nanoparticles are manufactured by a method which involves preparing a mixture which includes an organic solvent, urea (CH₄N₂O), salts of a noble metal and a non-noble transition metal, and optionally a carbon powder. The mixture may be stirred, sonicated and/or deaerated for a period of time, for example from about 1 minute to about an hour or more. The organic solvent may be removed from the mixture by evaporation to form dried powders. In one embodiment, the mixture may be dried completely using a rotary evaporator with a heating bath at 50° C. The dried powders may then be thermally annealed as described above to form a metal nitride core and a thin noble metal shell. In one embodiment, the annealing is performed in Ar gas for 2 hours at 500° C. at an ambient pressure. The nitriding treatment for the catalyst can also be carried out using a high-pressure nitriding system at 500° C. at a high pressure up to 10 MPa (1500 psi). Additionally, the annealed powders may be cooled down to room temperature under an Ar flow in a closed furnace. The manufacturing process is simple and cost-effective, providing nitride-doped nanoparticles with still higher catalytic activities and improved durability in combination with minimal loading of precious materials as compared with catalysts currently in use. Because this synthesis procedure does not involve a chemical reduction process in an aqueous solution, the possibility of oxidation of Ni cores is excluded, thereby leading to a higher activity for the ORR.

The mixture may comprise any suitable organic solvent. Examples of suitable organic solvents include but are not limited to acetone, chloroform, benzene, cyclohexane, dichloromethane, ethanol, diethyl ether, ethyl acetate, hexane, methanol, toluene, xylene, oleylamine, mixtures of two or more of these, and derivatives of one or more of these. The mixture may further comprise any of the metal salts mentioned above and nitrogen source such as urea. The solution may comprise a soluble salt of Ni and a soluble salt of Pt in an organic solution. The soluble salt of Ni may be, for example, Ni(acac)₂. The soluble salt of Pt may be, for example, Pt(acac)₂. Formation of the core/shell nanoparticles may be accomplished by annealing the dried powder at 400 to 820° C. under Ar to form a core comprising nickel nitride NiₓN (x=3 or 4). In other examples, the shell may comprise Pd, Au, or Ir.

A method for making a catalyst of the present disclosure nitrogen-doped platinum (Pt) containing nanoparticles comprising platinum (Pt) and nickel (Ni) having a carbon nitride coating on exterior surfaces thereof loaded on a carbon support for a fuel cell is also disclosed. In some examples, a dried precursor mixture undergoes nitridation to become nitrided wherein the carbon nitride coated nitrogen-doped platinum (Pt) containing catalyst structure is obtained. The method involves dispersing a platinum precursor, a nickel precursor, nitrogen source, and a carbon support material in a solvent to provide a precursor mixture, drying the precursor mixture, and annealing under a argon-containing gas flow at a temperature between about 200° C. to about 500° C. for about 2-3 hours forming carbon nitride coated nitrogen-doped platinum nickel nanoparticles on a carbon support. The nitrogen source is selected from urea, melamine, and aniline. In some examples, the nitrogen source is urea. The nitrogen source, such as urea is mixed with the nickel precursor. In some examples, the ratio of nickel to urea is 1:5 to 1:10. If the ratio of nickel to urea is too low, it will not generate enough of a nitriding environment to nitride the nickel. If the ratio is too high, it may form a very thick CNx coating, hindering mass transfer for the oxygen reduction reaction. In some examples, annealing may be conducted at a temperature of about 500° C., and in some examples, annealing is about 2 hours. The carbon nitride coating formed by methods of the present disclosure comprises CNx, wherein x represents the molar ratio of nitrogen (N) to carbon (C) in the range of 0.1<x≤4.

In some examples of the method of the present disclosure, the carbon support may be a mesoporous carbon support (MPC-HPDA) comprising a predetermined hierarchical pore distribution architecture, which comprises a plurality of pores with a majority percentage of the plurality of pores having an average pore diameter between about 2.0 nm to about 8.0 nm. In some examples, carbon nitride coated nitrogen-doped platinum nickel nanoparticles formed by methods of the present disclosure have an average particle diameter between about 1.5 nm and about 4.0 nm or between about 1.8 nm and about 3.0 nm. In some examples of the present disclosure, at least a portion of carbon nitride coated nitrogen-doped platinum nickel nanoparticles is disposed within the majority percentage of the plurality of pores having an average diameter between about 2.0 nm to about 8.0 nm. In some examples, the majority percentage of the plurality of pores of the mesoporous carbon support are mesopores having an average diameter between about 2.0 to 8.0 nm is more than 70%. The present disclosure also provides a fuel cell which comprises an anode, a cathode, and a polymer electrolyte membrane disposed between the anode and the cathode; and a cathode catalyst disposed on the cathode, wherein the cathode catalyst comprises nitrogen-doped platinum (Pt) containing nanoparticles having a carbon nitride coating on exterior surfaces thereof loaded on a carbon support.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis

### Example S1. SS-CNx-PtNiN/C

Nitrogen-doped platinum (Pt) containing nanoparticles comprising platinum (Pt) and nickel (Ni), having a carbon nitride coating on exterior surfaces thereof loaded on a carbon support (CNx-PtNiN) catalyst were synthesized as follows.

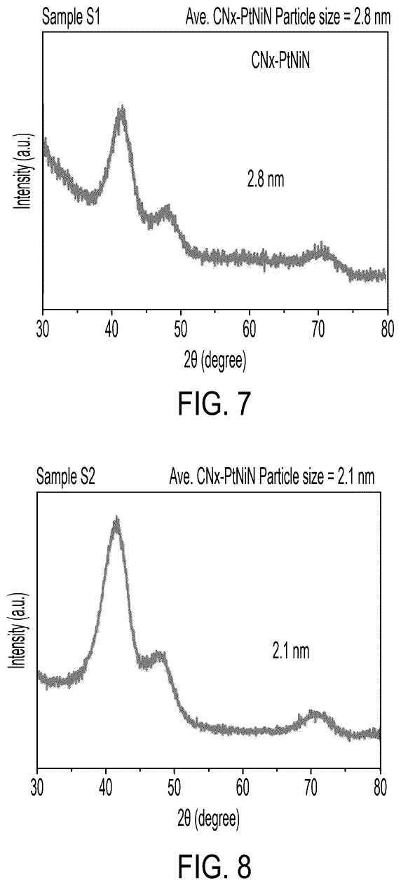

Precursors of PtNiN catalysts were prepared by dispersing 330 mg of Pt(acac)₂, 220 mg Ni(acac)₂ 520 mg urea, and 500 mg of mesoporous carbon particles having a predetermined hierarchical pore distribution architecture (“MPC-HPDA”) of the present disclosure. in 80 mL of acetone, followed by sonication for 2 hours. The resulting suspension was kept at room temperature with magnetic stirring for 2 hours and then the resulting mixture was dried by a rotating evaporator device to provide a dried precursor. The dried precursor was then annealed in a tube furnace under flowing Argon at 500° C. for 2 hours. The ratio of nickel to urea was 1:10 Carbon nitride coated nitrogen doped platinum nickel (CNx-PtNiN) nanoparticles with an average diameter equal to 2.8 nm loaded onto loaded onto mesoporous carbon black particles were obtained. XRD is provided in FIG. 7 showing the grain size of the CNx-PtNiN catalyst.

### Example S2. SS-CNx-PtNiN/MPC-HDPA

The catalyst was prepared in the same manner as Example S1, except that the ratio of nickel to urea was 1:5 and the dried precursor was annealed at 500° C. for 2 hours. CNx-PtNiN nanoparticles with an average diameter of about 2.1 nm loaded onto mesoporous carbon particles having a predetermined hierarchical pore distribution architecture (“MPC-HPDA”) of the present disclosure. X-Ray Diffraction (XRD) is provided in FIG. 8 showing the grain size of the CNx-PtNiN catalyst.

### Example S3. SS-CNx-PtNiN/MPC-HDPA

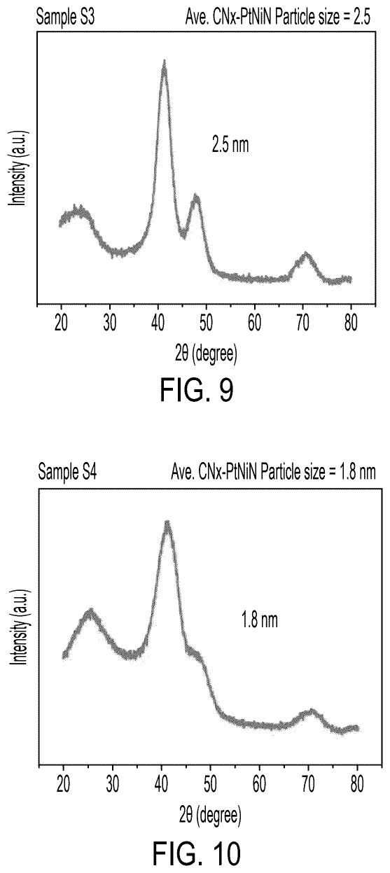

The catalyst was prepared in the same manner as Example S1, except the ratio of nickel to urea was 1:10 and the dried precursor was annealed at 200° C. for 3 hours followed by 500° C. for 2 hours. CNx-PtNiN nanoparticles with an average diameter equal to 2.5 nm loaded onto mesoporous carbon particles having a predetermined hierarchical pore distribution architecture (MPC-HPDA) of the present disclosure. XRD is provided in FIG. 9 showing the grain size of CNx-PtNiN.

### Example S4. CNx-PtNiN/MPC-HPDA

The catalyst was prepared in the same manner as Example S3, except the ratio of nickel to urea was 1:5. CNx-PtNiN nanoparticles with an average diameter equal to 1.8 nm loaded onto mesoporous carbon particles having a predetermined hierarchical pore distribution architecture (MPC-HPDA) of the present disclosure. XRD is provided in FIG. 10 showing the grain size of CNx-PtNiN.

### Example S5. CNx-PtNiN/MPC-HPDA

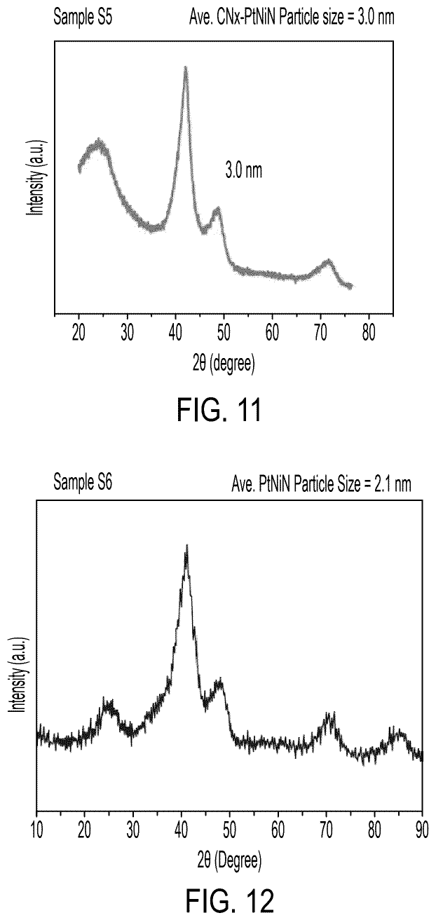

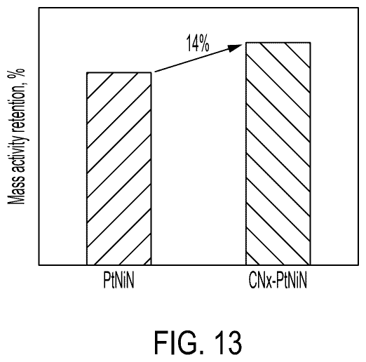

The catalyst was prepared in the same manner as Example S1, except the ratio of nickel to urea was 1:5 and the dried precursor was annealed at 200° C. for 3 hours followed by 500° C. for 3 hours. CNx-PtNiN nanoparticles with an average diameter equal to 3.0 nm loaded onto mesoporous carbon particles having a predetermined hierarchical pore distribution architecture (MPC-HPDA) of the present disclosure. XRD is provided in FIG. 11 showing the grain size of CNx-PtNiN.

### Example S6. SS-PtNiN/MPC-HPDA (Comparative)

Precursors of PtNiN catalysts were prepared by dispersing 330 mg of Pt(acac)₂, 220 mg Ni(acac)₂ and 500 mg of mesoporous carbon particles having a predetermined hierarchical pore distribution architecture (MPC-HPDA) in 80 mL of acetone, followed by sonication for 2 hours. The resulting suspension was kept at room temperature with magnetic stirring for 2 hours and then the resulting mixture was dried by a rotating evaporator device to provide a dried precursor. The dried precursor was then annealed in a tube furnace under flowing NH₃ at 560° C. for 9 hours PtNiN nanoparticles with an average diameter equal to 2.1 nm loaded onto loaded onto mesoporous carbon particles having a predetermined hierarchical pore distribution architecture (MPC-HPDA) were obtained. XRD is provided in FIG. 12 showing the grain size.

### Example 2. MEA Fabrication

The CNx-PtNiN catalysts were used to be cathode materials and evaluated in the MEA. The catalyst ink consisted of ethanol, water, ionomer, and catalysts. The ionomer to carbon (I/C) weight ratio and the solid content were kept at 0.85. The ink slurry was vigorously mixed and coated on a poly (tetrafluoro-ethylene) substrate (0.002″ thick, Macmaster-CARR) using a doctor-blade casting method. Similarly, a Pt/C (30 wt % Pt content, TEC10EA30E, TKK) catalyst layer with I/C ratio at 0.7 was prepared as the anode material. The coating layer was dried at 80° C. to remove the solvent. The coating layer was dried at 80° C. to remove the solvent. The final anode and cathode Pt loading were controlled at 0.05 and 0.1 mg Pt/cm².

An individual cathode and anode electrocatalyst layer (2 cm×2 cm) were punched and sandwiched between a Gore membrane to form a catalyst coated membrane (CCM) using a decal-transfer technique. The hot-pressing condition was 130° C., 0.8 MPa, and 5 mins. The gas diffusion layers (29 BC, SGL Carbon) together with CCM were assembled in a single cell with a serpentine flow field (Scribner Associates).

### Example 3. MEA Evaluation

A 850e Fuel Cell test system (Scribner Associates) was used for the catalyst stability evaluation. The MEAs with CNx-PtNiN catalysts were first activated by sweeping between 0.9 V to 0.1 V for several hundred times cycles under H₂/Air (1.5 NLPM/₂ NMPM) at 45° C. and 100% relative humidity (RH).

An accelerated stress test (AST) recommended by DOE was used to evaluate the durability of the CNx-PtNiN catalysts. A lower potential of 0.6 V (3 s) and an upper potential of 1V (3 s) was used in square wave for 10,000 cycles in H₂/N₂ (0.2 LPM L/0.2 LPM) at 60° C. and 80% RH.

The mass activity of CNx-PtNiN and PtNiN was compared with RDE (FIG. 14). The CNx-PtNiN catalyst shows an improved mass activity retention rate by 14% compared to PtNiN after stability tests in MEAs. This indicates that the CNx coating helps to prevent degradation of the catalyst nanoparticles.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A catalyst comprising:
nitrogen-doped platinum (Pt) containing nanoparticles comprising platinum (Pt) and nickel (Ni), having a carbon nitride (CN) coating on exterior surfaces thereof loaded on a carbon support, wherein said nanoparticles have an average diameter between about 1.5 nm to 8.0 nm.

2. The catalyst according to claim 1, wherein said nanoparticles have an average particle diameter between about 1.5 nm and about 4.0 nm.

3. The catalyst according to claim 1, wherein said nanoparticles have an average particle diameter between about 1.8 to about 3.0 nm.

4. The catalyst according to claim 1, wherein the carbon nitride coating comprises CNx, wherein x represents a molar ratio of nitrogen (N) to carbon (C) in a range of 0.1≤x≤4.

5. The catalyst according to claim 1, wherein the carbon support is a mesoporous carbon support comprising a predetermined hierarchical pore distribution architecture (MPC-HPDA), which comprises a plurality of pores with a majority percentage of the plurality of pores having an average pore diameter between about 2.0 nm to about 8.0 nm.

6. The catalyst according to claim 2, wherein at least a portion of said nanoparticles is disposed within a majority percentage of a plurality of pores having an average diameter between about 2.0 nm to about 8.0 nm.

7. The catalyst according to claim 5, wherein a majority percentage of a plurality of pores of the mesoporous carbon support are mesopores having an average diameter between about 2.0 to 8.0 nm is more than 70%.

8. A method for making a catalyst for a fuel cell, wherein the catalyst comprises nitrogen-doped platinum (Pt) containing nanoparticles having a carbon nitride coating on exterior surfaces thereof loaded on a carbon support, wherein said nitrogen-doped platinum (Pt) containing nanoparticles have an average diameter between about 2.0 nm to 8.0 nm, said method comprising:
dispersing a platinum precursor, a nickel precursor, nitrogen source, and a carbon support material in a solvent to provide a precursor mixture,
drying the precursor mixture and annealing under an Argon gas flow at a temperature between about 200° C. to about 500° C. for about 2-3 hours forming carbon nitride coated nitrogen-doped platinum nickel nanoparticles on a carbon support,
wherein the nitrogen source is selected from urea, melamine, and aniline, and
wherein said nanoparticles have an average diameter between about 1.5 nm to about 8.0 nm.

9. The method of claim 8, wherein the nitrogen source is urea.

10. The method according to claim 9, wherein a ratio of nickel to urea is 1:5 to 1:10.

11. The method according to claim 8, wherein the annealing is at a temperature of about 500° C.

12. The method according to claim 8, wherein the annealing is about 2 hours.

13. The method according to claim 8, wherein the carbon support is a mesoporous carbon support (MPC-HPDA) comprising a predetermined hierarchical pore distribution architecture, which comprises a plurality of pores with a majority percentage of the plurality of pores having an average pore diameter between about 2.0 nm to about 8.0 nm.

14. The method according to claim 8, wherein said nanoparticles have an average particle diameter between about 1.5 nm and about 4.0 nm.

15. The method according to claim 8, wherein said nanoparticles have an average particle diameter between about 1.8 nm and about 3.0 nm.

16. The method according to claim 8, wherein the carbon nitride comprises CNx, wherein x represents a molar ratio of nitrogen (N) to carbon (C) in a range of 0.1≤x≤4.

17. The method according to claim 8, wherein at least a portion of said nanoparticles is disposed within a majority percentage of a plurality of pores having an average diameter between about 2.0 nm to about 8.0 nm.

18. The method according to claim 13, wherein a majority percentage of a plurality of pores of the mesoporous carbon support (MPC-HPDA) are mesopores having an average diameter between about 2.0 to 8.0 nm is more than 70%.

19. A fuel cell comprising:
an anode, a cathode, and a polymer electrolyte membrane disposed between the anode and the cathode; and a cathode catalyst disposed on the cathode,
wherein the cathode catalyst comprises nitrogen-doped platinum (Pt) containing nanoparticles having a carbon nitride coating on exterior surfaces thereof loaded on a carbon support, and
wherein said nanoparticles have an average diameter between about 2.0 nm to about 8.0 nm.

20. The fuel cell according to claim 19, wherein the carbon nitride coating comprises CNx, wherein x represents a molar ratio of nitrogen (N) to carbon (C) in a range of 0.1≤x≤4.
